(19) United States
(12) Patent Application Publication
(10) Pub. No.: US 2015/0122215 A1
(43) Pub. Date: May 7, 2015

(54) COMBUSTION-SUPPORTING DEVICE FOR ENGINE

(71) Applicant: Kao-Shan LIN, Taipei (TW)

(72) Inventor: Kao-Shan LIN, Taipei (TW)

(21) Appl. No.: 14/595,286

(22) Filed: Jan. 13, 2015

Related U.S. Application Data
(63) Continuation-in-part of application No. 13/783,627, filed on Mar. 4, 2013.

(51) Int. Cl. F02M 33/00; F02M 25/035; F02M 25/025

(52) U.S. Cl. CPC F02M 33/00; F02M 25/025; F02M 25/035
USPC 123/25 A

(57) ABSTRACT

A combustion-supporting device for an engine includes a bottle that contains a liquid and plural boards that float on the liquid and are provided with plural vents arranged in a staggered manner. The bottle further has an inlet pipe and an outlet pipe. The inlet pipe extends into the liquid and the outlet pipe is connected to an intake manifold of the engine. With the boards, gaseous molecules can enter the engine through the outlet pipe to mix with the fuel and support combustion. As a result of complete combustion in the engine, waste gas and carbon deposits are reduced, and the engine operates smoothly and therefore coolly.

The current application is a continuation-in-part that claims a priority to the U.S. Utility patent application Ser. No. 13/783,627 filed on Mar. 4, 2013.

### BACKGROUND OF THE INVENTION

1. Technical Field

The present invention relates to combustion engines, and more particularly to a combustion-supporting device for an engine that supports combustion of gaseous molecules in the engine.

2. Description of Related Art

Generally, for an engine to operate, fuel undergoes explosion and combustion in cylinders so as to drive the engine. However, such combustion is unlikely to fully consume air and fuel, and consequently waste gas is increased and carbon undesirably deposits in the engine over time. As a known cure of this problem, water is technically introduced in a proper amount so that water molecules can support complete combustion, and in turn prevent increased waste gas and carbon deposits in the engine.

There are thus water combustion devices developed and commercially available. Such a device can generate small liquid drops that are guided into an engine through an intake manifold. As such small liquid drops typically have a high content of water the excessive moisture coming into the engine with the liquid drops can incur knocking in the engine and adversely affect combustion of fuel. In an even worse case, the engine may become rusty. In view of these problems, the inventor of the present invention believes that the existing water combustion devices need to be improved.

### SUMMARY OF THE INVENTION

The objective of the present invention is to provide a combustion-supporting device for an engine, which is able to filter out mist that contains too much moisture and only allow gaseous molecules to pass therethrough, so as to support complete combustion and smooth operation of the engine in a safer and cleaner way.

To achieve the foregoing objective, the disclosed combustion-supporting device comprises a bottle for containing a liquid. The bottle has a cover for closing the bottle. The cover is provided with an inlet pipe and an outlet pipe. The inlet pipe has two ends thereof defined as an inlet end and an outlet end, respectively. The inlet end of the inlet pipe is exposed outside the bottle. The outlet end of the inlet pipe is located within the bottle. The outlet pipe also has two ends thereof defined as an inlet end and an outlet end. The bottle contains therein a plurality of boards that are stacked and lifted by buoyancy in the liquid so that the boards move up and down in the bottle. Each said board has a transverse area approximately equal to a transverse area of the bottle. Each said board has centrally an upward extending upper tube and a downward extending lower tube. A through hole is defined in the board jointly by the upper tube and the lower tube. The lower tube of each said board is connected to the upper tube of another said board adjacent thereto from below so that each two said adjacent boards are fixed and separated by a distance, which defines an accommodating space between the two boards. The upper tubes and the lower tubes of all these boards jointly form an intake channel. A flexible hose has one end connected to the upper tube of the upmost board and has an opposite end connected to the outlet end of the inlet pipe so that the intake channel is communicated with the inlet pipe. The boards are provided with a plurality of vents. A base board is deposited below the boards and has centrally an upward extending connecting tube so that the base board is connected to the lower tube of the bottommost board through the connecting tube and fixed to the boards, thereby moving up and down with the boards. The connecting tube is communicated with the intake channel. The base board being provided with a plurality of through bores. The base board has an isolating ring extending from a bottom thereof downward, and the isolating ring is located between the connecting tube of the base board and the through bores of the base board, so that when the base board moves downward and the isolating ring abuts against a bottom of the bottle, the isolating ring isolates the connecting tube from the through bores of the base board, so that connecting tube and the through bores of the base board are not communicated.

With the boards, the disclosed combustion-supporting device is able to filter out mist that contains too much moisture and only allow gaseous molecules to pass therethrough, so as to support complete combustion and smooth operation of the engine in a safer and cleaner way. As a result of complete combustion in the engine, waste gas and carbon deposits are reduced, and the engine operates smoothly and therefore coolly.

### BRIEF DESCRIPTION OF THE DRAWINGS

FIG. 1 is a perspective view of a first embodiment of the present invention.

FIG. 2 is an exploded view of the first embodiment of the present invention.

FIG. 3 is an exploded view of the first embodiment of the present invention taken from a different viewpoint.

FIG. 4 is a cross-sectional view of the first embodiment of the present invention.

FIG. 5 is an applied view of the first embodiment of the present invention.

FIG. 6 is an applied view of the first embodiment of the present invention, showing that there is no liquid in the bottle.

FIG. 7 is a perspective view of a second embodiment of the present invention.

### DETAILED DESCRIPTION OF THE INVENTION

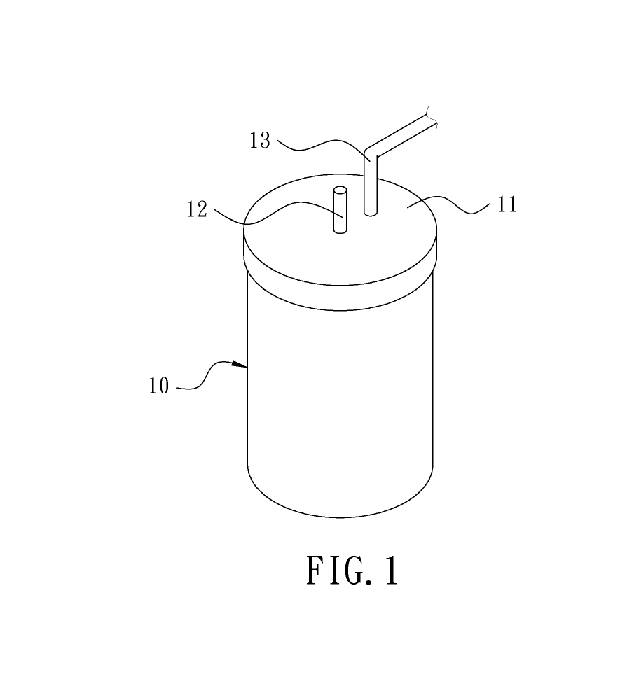

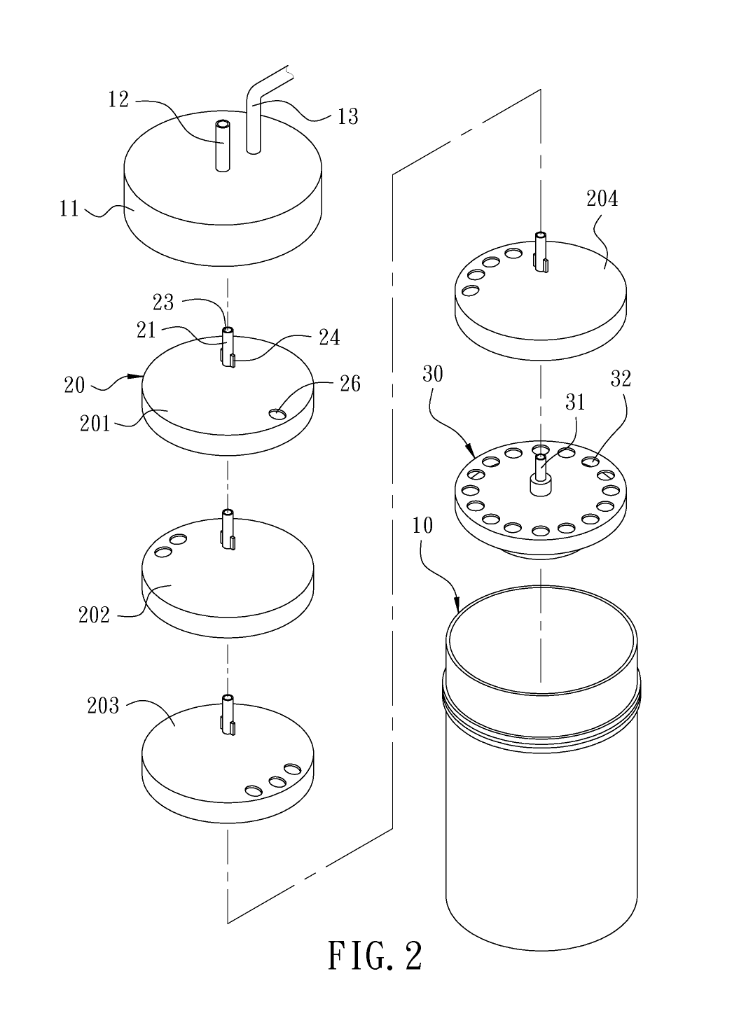

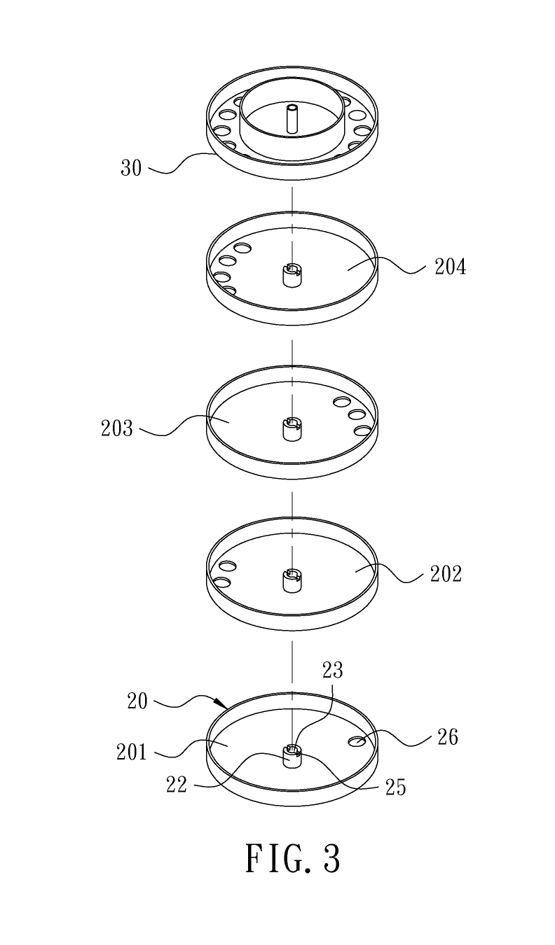

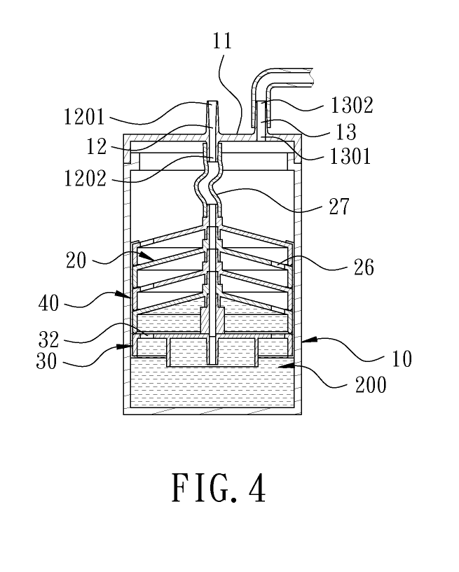

Please refer to FIG. 1 through FIG. 5 for a perspective view, an exploded view, cross-sectional views and applied views of the first embodiment of the present invention. As shown, a combustion-supporting device for an engine comprises a bottle 10, plural boards 20, a base board 30, and a retaining film 40.

The bottle 10 contains therein a liquid 200. In the first embodiment of the present invention, the liquid 200 is water but not limited thereto. The liquid 200 may be alternatively ethanol or a solution of ethanol in water, and in either case is similarly effective because ethanol that has a low ignition point and a high volatility is also combustion-supporting. The bottle 10 is covered by a cover 11. The cover 11 has an inlet pipe 12 and an outlet pipe 13. The inlet pipe 12 has its two ends defined as an inlet end 1201 and an outlet end 1202, respectively. The inlet end 1201 of the inlet pipe 12 is exposed outside the bottle 10. The outlet end 1202 of the inlet pipe 12 is located in the bottle 10. The two ends of the outlet pipe 13 are also defined as an inlet end 1301 and an outlet end 1302, respectively. The inlet end 1301 of the outlet pipe 13 is located inside the top of the bottle 10. The outlet end 1302 of the outlet pipe 13 is exposed outside the bottle 10, and can be connected to an intake manifold of the engine, so that the combustion-supporting device is communicated with the engine.

The boards 20 are stacked in the bottle 10. The boards 20 is lifted by buoyancy in the liquid 200 in the bottle 10 so that the boards 20 move up and down in the bottle 10. The boards 20 are herein successively defined as a first board 201, a second board 202, a third board 203, and a fourth board 204. Each of the boards 20 has a transverse area approximately equal to that of the bottle 10. Each of the boards 20 slopes downward and outward from a center thereof, so that the board 20 has a cone surface. Each of the boards 20 has centrally an upward extending upper tube 21 and a downward extending lower tube 22. A through hole 23 is defined in the board 20 jointly by the upper tube 21 and the lower tube 22. The lower tube 22 of each said board 20 is connected to the upper tube 21 of another said board 20 adjacent thereto from below so that each two said adjacent boards 20 are fixed. The upper tube 21 has a positioning plate 24 radially extending outward from a peripheral wall thereof, and the upper tube 21 has a positioning socket 25 corresponding to the positioning plate 24, so that the positioning plate 24 of one said board 20 engages with the positioning socket 25 of another said board 20 adjacent thereto from above, and the boards 20 are positioned with respect to each other. The adjacent boards 20 are separated by a distance, which defines an accommodating space between the two boards 20. The upper tubes 21 and the lower tubes 22 of all these boards 20 jointly form an intake channel. A flexible hose 27 has one end connected to the upper tube 21 of the first board 201, and the hose has an opposite end connected to the outlet end 1202 of the inlet pipe 12 so that the intake channel is communicated with the inlet pipe 12 and the inlet pipe 12 can extend into the liquid 200. The boards 20 have a plurality of vents 26. Therein, numbers of the vents 26 on the boards 20 are decreased progressively from the bottommost board 20 to the upmost board 20, and the vents 26 of two adjacent said boards 20 are staggered.

The base board 30 is below the boards 20. The base board 30 has centrally an upward extending connecting tube 31 so that the base board 30 is connected to the lower tube 22 of the bottommost board 20 through the connecting tube 31 and fixed to the boards 20, thereby moving up and down with the boards 20. The connecting tube 31 is communicated with the intake channel. The base board 30 is provided with a plurality of through bores 32. The base board 30 has an isolating ring 33 extending from a bottom thereof downward. The isolating ring is located between the connecting tube 31 of the base board 30 and the through bores 32 of the base board 30, so that when the base board 30 moves downward and the isolating ring 33 abuts against a bottom of the bottle 10, the isolating ring 33 isolates the connecting tube 31 from the through bores 32 of the base board 30, so that connecting tube 31 and the through bores 32 of the base board 30 are not communicated.

The retaining film 40 wraps the boards 20 and the base board 30 at their peripheries, for retaining the boards 20 and the base board 30.

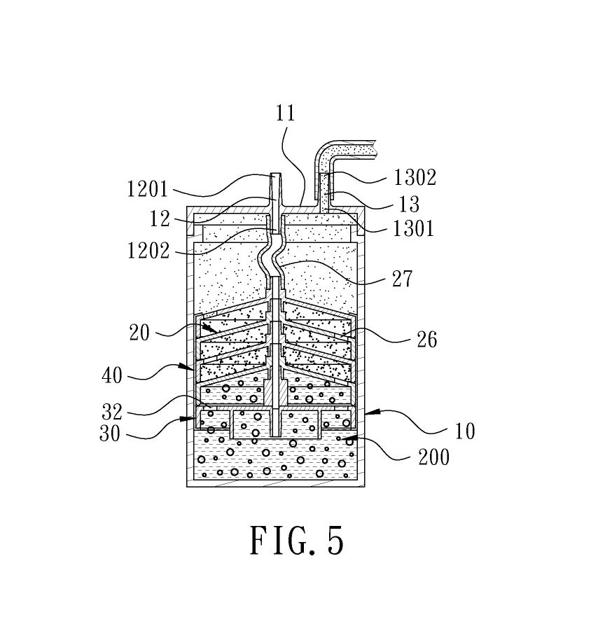

Referring to FIG. 5, when the engine operates, the negative pressure generated by intake manifold causes negative pressure inside the bottle 10, so inlet pipe 12 of the bottle 10 draws air in. At this time, by means of the intake channel, the outlet end 1202 of the inlet pipe 12 can extend into the liquid 200, so that air output by the inlet pipe 12 of the bottle 10 generates air bubbles, thereby increasing the contacting area between the air and the liquid 200 as it exists in the liquid 200. This helps to increase dissolved oxygen in the liquid 200. The air bubbles break at the surface of the liquid 200 and mist containing oxygen is formed. The mist then passes through the vents 26 of the boards 20 meandrously as it is drawn at the inlet end 1301 of the outlet pipe 13 of the bottle 10. Then the mist is drawn into the engine through the outlet pipe 13 of the bottle 10.

When the mist then passes through the vents 26 of the boards 20 meandrously, the boards 20 serve to absorb mist that contains too much moisture so that water condenses on the boards 20, and only gaseous molecules that contain oxygen can pass the vents 26. In this way, the mist that contains too much moisture is filtered out, and the water molecules passing through the outlet pipe 13 of the bottle 10 are gaseous oxygen-containing molecules. When entering the engine, the gaseous molecules mix with fuel for explosion and combustion, and oxygen contained therein helps to generate hydrogen at high temperature, thereby supporting combustion. As a result of complete combustion in the engine, waste gas can be reduced and carbon deposits can even be eliminated, without having too much moisture in the engine. The engine can thereby operate more smoothly, and since the gaseous molecules can absorb latent heat in the high-temperature environment in the engine, the engine operates more coolly. It is to be noted that the vents 26 of the adjacent boards 20 are arranged in a staggered manner, so they are not aligned with each other. This arrangement facilitates separation between gaseous and liquid phases. In addition, the numbers of the vents 26 on the boards 20 are decreased progressively from the bottommost board to the upmost board, for further enhance said separation.

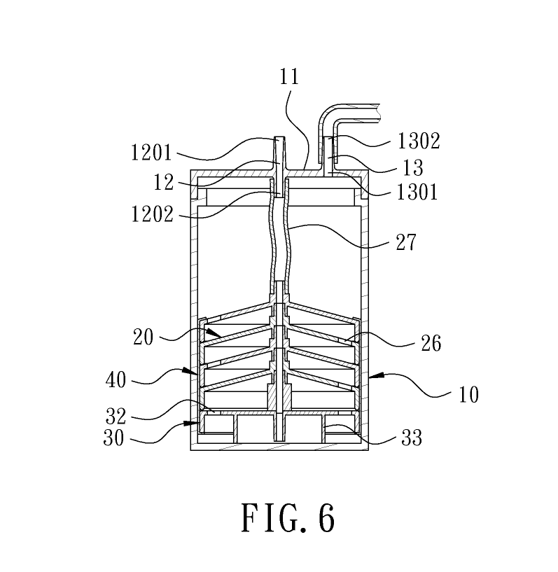

Referring to FIG. 6, in the first embodiment of the present invention, when the liquid in the bottle 10 is used up and not refilled timely, the base board 30 is released by the buoyancy and moves downward by gravity to the bottom of the bottle 10, so that the isolating ring 33 abuts against the bottom of the bottle 10, thereby isolating the connecting tube 31 from the through bores 32 of the base board 30. At this time, the connecting tube 31 and the through bores 32 in the base board 30 are disconnected, and air is prevented from drawn into the engine directly.

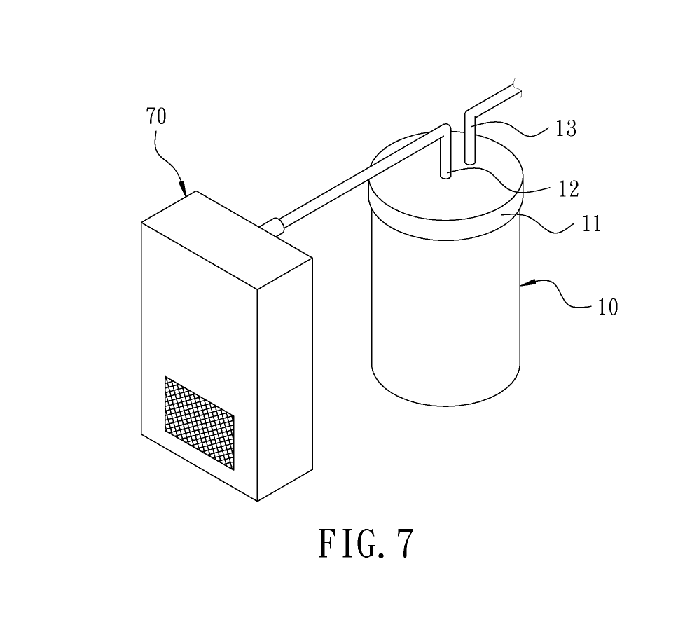

FIG. 7 depicts the second embodiment of the present invention, which is different from the first embodiment for it further comprises a pump 70 that is connected to the inlet end 1201 of the bottle 10. The pump 70 bumps air into the bottle 10 forcibly. Thereby, the combustion-supporting device is also applicable to diesel engines, turbines and boilers that do not generate negative pressure, for providing the same effects and advantages as those realized by the previous embodiment.

What is claimed is:

1. A combustion-supporting device for an engine, comprising:
at least one bottle, containing therein a liquid and having atop a cover that closes the bottle, the cover being provided with an inlet pipe and an outlet pipe, the inlet pipe having two ends thereof defined as an inlet end and an outlet end, respectively, the inlet end of the inlet pipe being exposed outside the bottle, the outlet end of the inlet pipe being located within the bottle, and the outlet pipe also having two ends thereof defined as an inlet end and an outlet end;
a plurality of boards, being stacked in the bottle and lifted by buoyancy in the liquid so that the boards move up and down in the bottle, each said board having a transverse area approximately equal to a transverse area of the bottle, each said board having centrally an upward extending upper tube and a downward extending lower tube, a through hole being defined in the board jointly by the upper tube and the lower tube, the lower tube of each said board being connected to the upper tube of another said board adjacent thereto from below so that each two said adjacent boards are fixed and separated by a distance, which defines an accommodating space between the two boards, the upper tubes and the lower tubes of all these boards jointly forming an intake channel, a flexible hose having one end connected to the upper tube of the upmost board, the hose having an opposite end connected to the outlet end of the inlet pipe so that the intake channel is communicated with the inlet pipe, and the boards being provided with a plurality of vents;
a base board, being deposited below the boards and having centrally an upward extending connecting tube so that the base board is connected to the lower tube of the bottommost board through the connecting tube and fixed to the boards, thereby moving up and down with the boards, the connecting tube being communicated with the intake channel, the base board being provided with a plurality of through bores, the base board having an isolating ring extending from a bottom thereof downward, and the isolating ring being located between the connecting tube of the base board and the through bores of the base board, so that when the base board moves downward and the isolating ring abuts against a bottom of the bottle, the isolating ring isolates the connecting tube from the through bores of the base board, so that connecting tube and the through bores of the base board are not communicated.

2. The combustion-supporting device of claim 1, wherein each said board slopes downward and outward from a center thereof, so that the board has a cone surface.

3. The combustion-supporting device of claim 1, wherein numbers of the vents on the boards are decreased progressively from the bottommost board to the upmost board, and the vents of two adjacent said boards are staggered.

4. The combustion-supporting device of claim 1, wherein the upper tube has a positioning plate radially extending outward from a peripheral wall thereof, and the upper tube has a positioning socket corresponding to the positioning plate, so that the positioning plate of one said board engages with the positioning socket of another said board adjacent thereto from above, and the boards are positioned with respect to each other.

5. The combustion-supporting device of claim 1, further comprising a pump that is connected to the inlet end of the bottle, wherein the pump bumps air into the bottle forcibly.
